(19) United States
(12) Patent Application Publication
(10) Pub. No.: US 2023/0230567 A1
(43) Pub. Date: Jul. 20, 2023

(54) ELECTRONIC PERCUSSION INSTRUMENT AND HIT DETECTION METHOD

(71) Applicant: Roland Corporation, Shizuoka (JP)

(72) Inventor: Kiyoshi YOSHINO, Hamamatsu, Shizuoka (JP)

(73) Assignee: Roland Corporation, Shizuoka (JP)

(21) Appl. No.: 18/022,743

(22) PCT Filed: Aug. 26, 2020
(86) PCT No.: PCT/JP2020/032216

§ 371 Date: Feb. 22, 2023

(51) Int. Cl. G10H 3/14; G10H 1/34; G10D 13/10; G10H 1/00

(52) U.S. Cl. CPC G10H 3/146; G10H 1/34; G10D 13/26; G10H 1/0008; G10H 2220/525

(57) ABSTRACT

Provided are an electronic percussion instrument and a hit detection method. An overhang portion constituting the outer edge part of an edge frame is positioned further radially outward than the outer edge of a bow frame. Consequently, when the overhang portion is hit, the vibration resulting from the hit is detected by an edge sensor attached to the edge frame. In this way, it is possible to detect whether the overhang portion (the edge portion of an electronic cymbal has been hit by means of vibration detection by the edge sensor instead of by means of pressure detection by a sheet sensor.

### TECHNICAL FIELD

The disclosure relates to an electronic percussion instrument and a hit detection method, and more particularly to an electronic percussion instrument and hit detection method capable of improving hit detection accuracy.

### RELATED ART

There is a technique for detecting a hit on the edge of an electronic cymbal. For example, Patent Literature 1 describes an electronic cymbal in which a sheet sensor 7 is pinched between an upper surface of an edge portion of a frame 3 and a cover 2 covering the upper surface of the frame 3. According to this electronic cymbal, since the sheet sensor 7 detects the pressure when the edge portion of the frame 3 (cover 2) is hit, it is possible to determine whether the edge portion is hit or not based on the detected pressure.

### CITATION LIST

### Patent Literature

[Patent Literature 1] Japanese Patent Laid-Open No. Japanese Laid-Open No. 2002-207481 (for example, paragraphs 0034 to 0035 and FIGS. 1 and 2)

### SUMMARY

### Technical Problem

However, with the above-described conventional technique, when the performer hits the edge portion from the side with the stick in an upright orientation, or when the edge portion is hit lightly, the sheet sensor may not detect the pressure. Therefore, there is a problem that the hit on the edge portion cannot be detected with high accuracy.

The disclosure has been made in view of the above, and provides an electronic percussion instrument and a hit detection method capable of improving the accuracy of hit detection.

### Solution to Problem

To achieve the above, an electronic percussion instrument according to the disclosure includes: a first frame having an upper surface configured as a hit surface; a first sensor attached to the first frame for detecting vibration of a hit to the first frame; a second frame disposed below the first frame in a non-contact state with the first frame and having an outer edge that is located on an outer peripheral side of an outer edge of the first frame to form an edge portion; and a second sensor attached to the second frame for detecting vibration of a hit to the second frame.

A hit detection method for an electronic percussion instrument according to the disclosure is provided. The electronic percussion instrument includes: a first frame having an upper surface configured as a hit surface; a first sensor attached to the first frame for detecting vibration of a hit to the first frame; a second frame disposed below the first frame in a non-contact state with the first frame and having an outer edge that is located on an outer peripheral side of an outer edge of the first frame to form an edge portion; and a second sensor attached to the second frame for detecting vibration of a hit to the second frame. The hit detection method includes: determining which of the first frame and the second frame has been hit based on a ratio or difference between output values of the first sensor and the second sensor.

### BRIEF DESCRIPTION OF THE DRAWINGS

FIG. 1 is an exploded perspective view of the electronic cymbal in an embodiment.

FIG. 2 is a cross-sectional view of the electronic cymbal.

FIG. 3 is a cross-sectional view of the electronic cymbal showing a state in which the overhang portion of the edge frame is hit from the state in FIG. 2.

FIG. 4 is a cross-sectional view of the electronic cymbal showing a state in which choke is played.

### DESCRIPTION OF THE EMBODIMENTS

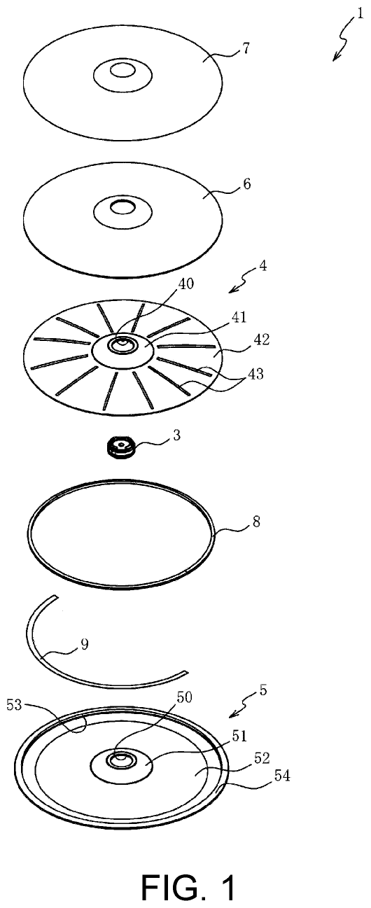

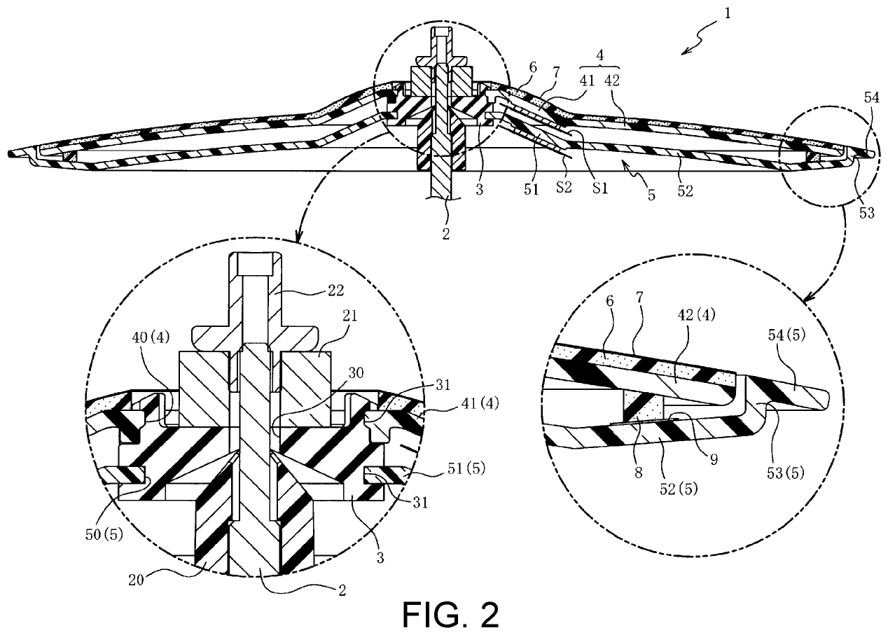

Hereinafter, exemplary embodiments will be described with reference to the accompanying drawings. First, a configuration of an electronic cymbal 1 will be described with reference to FIGS. 1 and 2. FIG. 1 is an exploded perspective view of the electronic cymbal 1 in an embodiment. FIG. 2 is a cross-sectional view of the electronic cymbal 1. FIG. 2 shows a cross section taken along a plane along the axis of the electronic cymbal 1. Further, in FIG. 2, hatching of a film member 7 is omitted in order to simplify the drawing.

As shown in FIGS. 1 and 2, the electronic cymbal 1 is a disk-shaped electronic percussion instrument that simulates an acoustic cymbal. The electronic cymbal 1 is supported by a rod 2 (see FIG. 2) via a support rubber 3.

The rod 2 includes a support 20 for restricting the downward of the electronic cymbal 1 (see the left enlarged part of FIG. 2). The support 20 is a cylindrical body that is tapered toward the upper end, and is attached to the rod 2 in a state in which downward displacement is restricted.

The support rubber 3 is formed in a cylindrical shape having a through hole 30 in the center, and is configured such that the support rubber 3 is hooked to the support 20 by passing the rod 2 through the through hole 30 of the support rubber 3, and the electronic cymbal 1 is supported on the rod 2 in this way. After attaching a cylindrical felt washer 21 to the rod 2 to overlap the support rubber 3 in the supported state, by fastening a tightening nut 22 to the rod 2 while compressing the felt washer 21, the electronic cymbal 1 is supported in a swingable state with respect to the rod 2.

A groove 31 extending in the circumferential direction is formed in the outer peripheral surface of the support rubber 3. A pair of grooves 31 are formed on the outer peripheral surface of the support rubber 3 at predetermined intervals in the vertical direction, and the inner edge parts of a bow frame 4 and an edge frame 5 are fitted into the pair of grooves 31 respectively.

The bow frame 4 and the edge frame 5 are disk-shaped frames having through holes 40 and 50 in the center for fitting the support rubber 3 (groove 31). The bow frame 4 and the edge frame 5 are made of synthetic resin, fiber-reinforced resin, or the like. A bow sensor S1 and an edge sensor S2 are attached to the bow frame 4 and the edge frame 5.

The bow sensor S1 and the edge sensor S2 are piezo pickups (piezoelectric elements), respectively. The bow sensor S1 detects the vibration when the bow frame 4 is hit, and the edge sensor S2 detects the vibration when the edge frame 5 is hit. Hits detected by the bow sensor S1 and the edge sensor S2 are converted into electrical signals and input to a sound source device (not shown). As a result, musical sounds corresponding to hits on the bow frame 4 and the edge frame 5, that is, bow sounds when the bow frame 4 is hit and edge sounds when the edge frame 5 is hit are generated.

The bow frame 4 is a frame that configures substantially the entire upper surface (hit surface) of the electronic cymbal 1, and the edge frame 5 is a frame that configures the outer edge portion of the upper surface (hit surface) of the electronic cymbal 1. The bow frame 4 includes a bell portion 41 simulating the bell of an acoustic cymbal and a bow portion 42 simulating a bow.

The bell portion 41 is formed in a bowl shape that is inclined downward radially outward from the center of the bow frame 4, and the bow portion 42 is formed in an annular shape that is inclined downward radially outward from the outer edge of the bell portion 41. The bow sensor S1 is attached to the lower surface of the bell portion 41. That is, since the bow sensor S1 is disposed closer to the center near the rod 2 than the outer edge of the bow frame 4, even if the bow frame 4 is hit at different positions in the circumferential direction, the length of the vibration propagation path from each hit position to the bow sensor S1 may be made uniform. Therefore, it is possible to make the hit sensitivity distribution uniform regardless of the difference in the hit position on the bow frame 4 in the circumferential direction.

The edge frame 5 includes an inner peripheral portion 51 vertically facing the bell portion 41 of the bow frame 4 and an outer peripheral portion 52 vertically facing the bow portion 42 of the bow frame 4. The edge sensor S2 is attached to the lower surface of the inner peripheral portion 51. That is, the edge sensor S2 is disposed at a position overlapping the bell portion 41 of the bow frame 4 when viewed in the vertical direction, and closer to the center than the outer edge of the edge frame 5 and closer to the rod 2. Therefore, it is possible to make the hit sensitivity distribution uniform regardless of the difference in the hit position on the edge frame 5 in the circumferential direction.

An inner peripheral portion 51 of the edge frame 5 is formed in a bowl shape that is inclined downward from the center side of the edge frame 5 toward the outside in the radial direction. That is, the inner peripheral portion 51 of the edge frame 5 is formed in the same shape as the bell portion 41 of the bow frame 4.

The outer peripheral portion 52 of the edge frame 5 is formed in an annular shape that is inclined downward from the outer edge of the inner peripheral portion 51 toward the outside in the radial direction, and the outer peripheral portion 52 as a whole is formed substantially in the same shape as the bow portion 42 of the bow frame 4. In addition, the portion on the outer edge side of the outer peripheral portion 52 is slightly inclined upward to approach the outer edge of the bow portion 42 of the bow frame 4, and a bent portion 53 is bent upward from the outer edge of the upwardly inclined outer peripheral portion 52.

From the upper end side of the bent portion 53, an overhang portion 54 is overhanging in a flange shape toward the outer peripheral side (outside in the radial direction). The edge frame 5 is configured by forming the inner peripheral portion 51, the outer peripheral portion 52, the bent portion 53, and the overhang portion 54 as one piece.

The overhang portion 54 forming the outer edge part of the edge frame 5 is located on the outer peripheral side (outside in the radial direction) of the outer edge of the bow portion 42 of the bow frame 4, and the overhang portion 54 forms an edge portion of the upper surface of the electronic cymbal 1. Therefore, when the performer plays the electronic cymbal 1 by hitting the edge portion of the electronic cymbal 1, the overhang portion 54 is hit. Vibration when the overhang portion 54 is hit is detected by the edge sensor S2 attached to the edge frame 5.

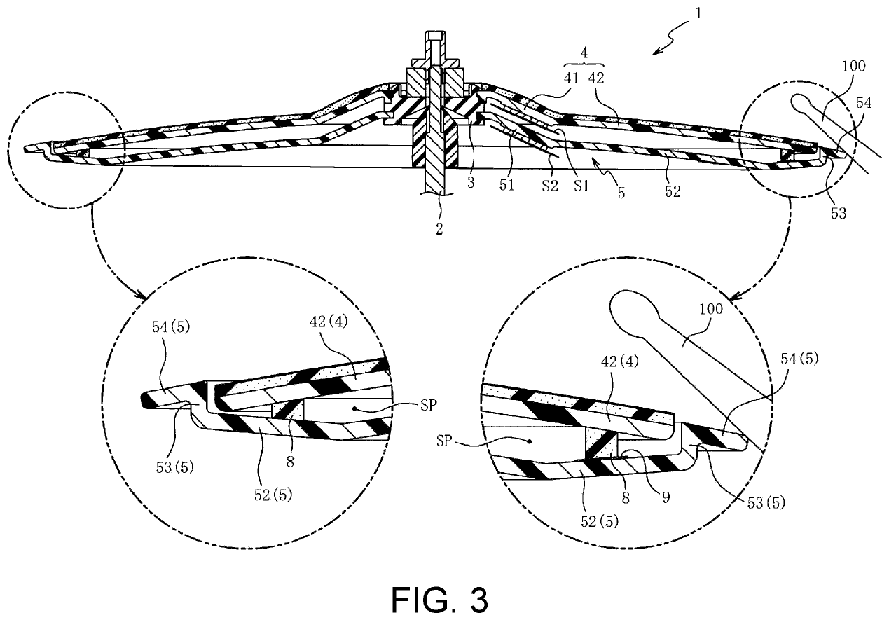

In other words, it is possible to detect whether the overhang portion 54 (the edge portion of the electronic cymbal 1) has been hit by vibration detection by the edge sensor S2 instead of by pressure detection by a sheet sensor as in the conventional technology. It is thus possible to detect a hit with suitable precision even when the performer hits the overhang portion 54 from the side with a stick 100 (see FIG. 3) in an upright orientation or when the overhang portion 54 is hit lightly.

In addition, in a supported state in which the bow frame 4 and the edge frame 5 (hereinafter also referred to as “each frame”) are supported by the rod 2 via the support rubber 3, each of the frames are in a non-contact state. Therefore, it is possible to prevent the bow sensor S1 (edge sensor S2) attached to the bow frame 4 (edge frame 5) from erroneously detecting vibration when the edge frame 5 (bow frame 4) is hit.

Therefore, based on the ratio or difference between the output values of the bow sensor S1 and the edge sensor S2, by determining that the frame with the larger output value of the sensor has been hit, it is possible to accurately determine which of the bow frame 4 and the edge frame 5 (overhang portion 54) has been hit.

In addition, since the bow frame 4 and the edge frame 5 are each supported by the rod 2 via the rubber-like elastic support rubber 3, the vibration when each frame is hit may be damped by the support rubber 3. Therefore, when one of the frames is hit, the vibration may be suppressed from being propagated to the other frame via the support rubber 3; therefore, it is possible to accurately determine which of the bow frame 4 and the edge frame 5 (overhang portion 54) has been hit.

Here, since an acoustic cymbal is made of metal and has a relatively small coefficient of friction, it is possible to hit the acoustic cymbal by sliding the stick on the upper surface of the acoustic cymbal. Therefore, in this embodiment, the upper surface and the outer peripheral surface of the overhang portion 54 of the edge frame 5 are not covered with a cover (cushioning material) such as rubber. As a result, it is possible to hit the overhang portion 54 by sliding the stick on the overhang portion 54; therefore, it is possible to impart a feeling of playing similar to that of an acoustic cymbal.

When the overhang portion 54 of the edge frame 5 is not covered with a cushioning material as in this embodiment, it is preferable to form the edge frame 5 using a fiber reinforced resin (for example, glass fiber reinforced nylon). As a result, since the strength of the edge frame 5 may be ensured, damage to the edge frame 5 may be suppressed even if the overhang portion 54 is directly hit.

As described above, when an acoustic cymbal is played, it is possible to hit the acoustic cymbal by sliding the stick on the upper surface. In order to simulate such a feeling of hitting during playing, it is better not to cover the frame with a cushioning material such as rubber. However, in a structure in which the cover is simply removed from the frame of the conventional electronic cymbal (for example, Japanese Patent Application Laid-Open No. 2002-207481) and the frame is hit directly, the hitting sound becomes loud when the cymbal is hit with a stick or the like.

That is, in the configuration of the conventional electronic cymbal, there is a problem that it is difficult to achieve both reduction of the hitting sound at the time of hitting and to obtain a feeling of playing (feeling of hitting) like an acoustic cymbal. In this regard, this embodiment adopts a configuration capable of addressing this issue. This configuration will be described below.

The upper surface of the bow frame 4 is covered with a cover member 6 made of foamed resin (polyurethane foam in this embodiment). The cover member 6 has a through hole in the center and is formed in a disc shape having substantially the same shape as the bow frame 4, and is attached to the bow frame 4 to cover the upper surface of the bow frame 4 from the inner edge to the outer edge.

Since the cover member 6 is made of foamed resin which is softer than rubber, the cover member 6 may absorb the impact of hitting with a stick or the like. Therefore, the hitting sound the time of hitting the bow frame 4 may be effectively reduced. In addition, since the cover member 6 made of foamed resin is easily damaged when directly hit, the upper surface of the cover member 6 is covered with the film member 7.

The film member 7 is a plain weave fabric (mesh) formed using synthetic fibers (polyester in this embodiment). The film member 7 is formed in a disc shape having a through hole in the center, and covers the upper surface of the cover member 6 from the inner edge to the outer edge. Since the film member 7 formed using synthetic fibers has higher strength than the cover member 6 made of foamed resin, the film member 7 may protect the cover member 6 from hit.

Furthermore, since the film member 7 is a plain weave fabric made of synthetic fibers, it has a lower coefficient of friction than rubber. Therefore, since it is possible to hit the upper surface of the film member 7 by sliding the stick over it, it is possible to impart a feeling of playing close to that of an acoustic cymbal.

That is, as in this embodiment, the upper surface of the bow frame 4 made of resin is covered with the cover member 6 made of foamed resin, and the upper surface of the cover member 6 is covered with the film member 7 which is a woven fabric formed using synthetic fibers; in this way, it is possible to reduce the hitting sound the time of hitting and to provide the feeling of playing like that of an acoustic cymbal.

Further, the upper surface of the film member 7 and the upper surface of the overhang portion 54 of the edge frame 5 are configured to be flush with each other before hitting. As a result, even when the upper surface of the electronic cymbal 1 includes two frames, the bow frame 4 and the edge frame 5, the shape of the upper surface may be approximated to that of an acoustic cymbal.

The bow frame 4 is formed with multiple slits 43 (see FIG. 1) penetrating vertically, and the slits 43 divide the bow frame 4 into multiple regions. As a result, the propagation of vibration when the bow frame 4 (film member 7) is hit is blocked by the slit 43, so that the entire bow frame 4 may be prevented from vibrating when the bow frame 4 is hit. Therefore, the hitting sound at the time of hitting the bow frame 4 may be reduced more effectively.

When the slit 43 is formed in the bow frame 4 as in this embodiment, it is preferable to form the bow frame 4 using a fiber reinforced resin (for example, glass fiber reinforced nylon). As a result, the rigidity of the bow frame 4 may be ensured even when the slit 43 penetrating vertically are formed.

In this way, when forming the slit 43 to suppress the vibration of the entire bow frame 4, it is possible to form the slit 43 in a curved shape extending in the circumferential direction, for example. However, with such a configuration, when the bow portion 42 of the bow frame 4 is hit, the propagation of vibration toward the bow sensor S1 is likely to be blocked by the slit 43.

In this regard, in this embodiment, multiple (12 in this embodiment) linear slits 43 extending in the radial direction are provided side by side in the bow portion 42 of the bow frame 4 at equal intervals in the circumferential direction. That is, the multiple slits 43 are formed radially around the bell portion 41 where the bow sensor S1 is disposed. As a result, a vibration propagation path extending in the radial direction may be formed between the multiple slits 43, so that vibration when the bow portion 42 of the bow frame 4 is hit may be easily propagated to the bow sensor S1. Therefore, compared with the case where the slit 43 is formed in a curved shape extending in the circumferential direction, the hit to the bow portion 42 may be detected with high accuracy.

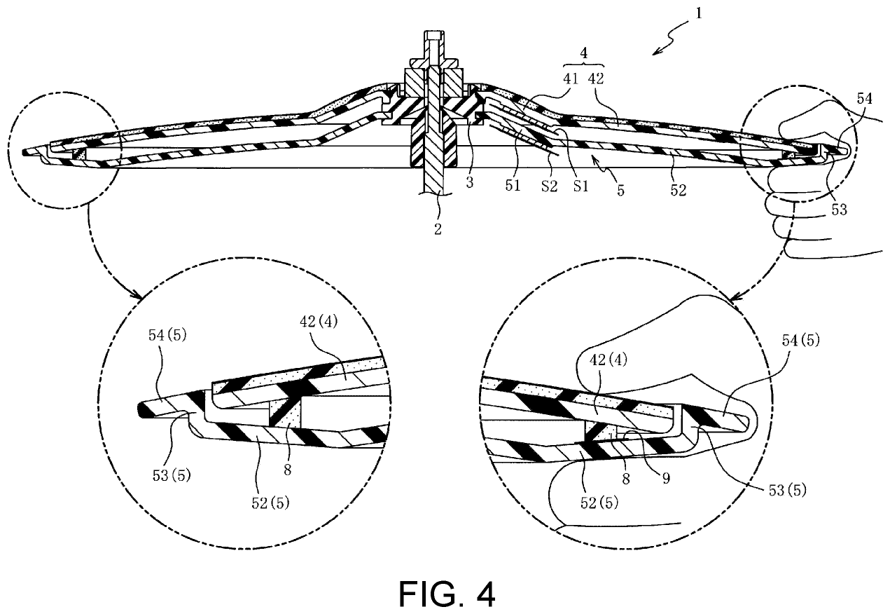

Next, the configuration of the electronic cymbal 1 will be further described with reference to FIGS. 3 and 4. FIG. 3 is a cross-sectional view of the electronic cymbal 1 showing a state in which the overhang portion 54 of the edge frame 5 is hit from the state in FIG. 2. FIG. 4 is a cross-sectional view of the electronic cymbal 1 showing a state in which choke is played.

As shown in FIG. 3, the inner edge parts of the bow frame 4 and the edge frame 5 are fitted in the support rubber 3 made of rubber. Therefore, when the overhang portion 54 of the edge frame 5 is hit by the stick 100 or the like, the edge frame 5 near the hit position is relatively displaced downward away from the bow frame 4 (see the enlarged part on the right side of FIG. 3). Due to this displacement of the edge frame 5, the edge frame 5 is relatively displaced to approach the bow frame 4 in the region opposite to the hit position with the rod 2 interposed therebetween.

Such relative displacement in which the frames approach each other also occurs when the bow frame 4 is hit. If the frames come into contact with each other due to this relative displacement, the vibration caused by hitting one frame is likely to be propagated to the other frame. Therefore, in this embodiment, a cushioning material 8 is disposed between the bow frame 4 and the edge frame 5.

The cushioning material 8 is formed in an annular shape that is continuous in the circumferential direction (see FIG. 1), and is disposed between the lower surface of the bow portion 42 of the bow frame 4 on the outer edge side and the outer peripheral portion 52 of the edge frame 5. In this way, the contact between each frame at the time of hitting may be restricted by the cushioning material 8. Since the cushioning material 8 is formed using a material having a predetermined elasticity (a material softer than each frame) such as sponge, rubber, or thermoplastic elastomer, when one of the frames is hit, it is possible to suppress propagation of vibration to the other frame by the cushioning material 8. Therefore, it is possible to accurately determine which of the frames has been hit.

In addition, the cushioning material 8 is formed in an annular shape that is continuous in the circumferential direction, and in a state before the bow frame 4 or the edge frame 5 is hit (hereinafter referred to as “state before hitting”), the bow frame 4 and the edge frame 5 (seat sensor 9 to be described later) are in contact with the cushioning material 8. That is, the space SP between the bow frame 4 and the edge frame 5 is closed by the cushioning material 8, and a (closed) space SP surrounded by the rod 2 (support rubber 3), the bow frame 4, the edge frame 5 and the cushioning material 8 is formed between the bow frame 4 and the edge frame 5.

As a result, it is possible to prevent the vibration of the bow frame 4 (film member 7) from propagating through the space SP between the bow frame 4 and the edge frame 5 and being released to the outside of the electronic cymbal 1; therefore, the hitting sound at the time of hitting the bow frame 4 may be reduced more effectively.

The cushioning material 8 is attached to the lower surface of the bow frame 4, and the thickness of the cushioning material 8 is formed thicker than the space between the lower surface of the bow frame 4 and the upper surface of the edge frame 5. Therefore, the cushioning material 8 is compressed by a predetermined amount between the bow frame 4 and the edge frame 5 in the state before hitting.

As a result, the cushioning material 8 may follow the displacement of the bow frame 4 and the edge frame 5 away from each other, so that the space SP between the bow frame 4 and the edge frame 5 is kept closed by the cushioning material 8 (see the enlarged part on the right side of FIG. 3). Therefore, it is possible to suppress the vibration of the bow frame 4 (film member 7) from propagating through the space SP and being released to the outside; therefore, the hitting sound at the time of hitting the bow frame 4 may be reduced more effectively.

When the space SP between the bow frame 4 and the edge frame 5 is closed by the cushioning material 8, the cushioning material 8 may be configured to be attached to each of the lower surface of the bow frame 4 and the upper surface of the edge frame 5 (seat sensor 9 to be described later). With this configuration, a state in which the space between the bow frame 4 and the edge frame 5 is closed by the cushioning material 8 may be reliably maintained.

In this way, since the cushioning material 8 is compressed by the relative displacement of the bow frame 4 or the edge frame 5, this embodiment adopts a configuration in which the compression of the cushioning material 8 is used to detect the choke playing.

Specifically, a seat sensor 9 is provided between the cushioning material 8 and the upper surface of the outer peripheral portion 52 of the edge frame 5. The seat sensor 9 is a strip-shaped membrane switch (pressure-sensitive sensor) that detects pressure changes.

As shown in FIG. 4, when the bow portion 42 of the bow frame 4 and the outer peripheral portion 52 of the edge frame 5 are held by the player, the seat sensor 9 is pinched between the cushioning material 8 and the outer peripheral portion 52 of the edge frame 5, and the pressure at the time of pinching is detected by the sheet sensor 9. Then, it is configured to attenuate (reduce or mute) the musical sound already generated by the hitting when the pressure detected by the seat sensor 9 reaches a predetermined pressure. This makes it possible to simulate choke playing in which the electronic cymbal 1 is hit and then muted.

In this case, when the acoustic cymbal is gripped by the player at any position where the player may grip it, the player may perform the choke playing regardless of the gripping position. On the other hand, as in conventional electronic cymbals (for example, Japanese Patent Laid-Open No. 2002-207481), in the case of a structure that detects choke playing when the seat sensor is pinched between the frame and the rubber cover, if the seat sensor is gripped at a position that is displaced from the seat sensor in the radial direction, the seat sensor may not detect sufficient pressure. Therefore, it is not possible to accurately detect that the choke playing has been performed.

In this regard, by providing the seat sensor 9 between the edge frame 5 and the cushioning material 8 as in this embodiment, even if the bow frame 4 and the edge frame 5 are gripped at a position displaced from the seat sensor 9 in the radial direction (for example, the inner side in the radial direction of the seat sensor 9), the seat sensor 9 may be pinched between each frame and the cushioning material 8. Therefore, compared with conventional electronic cymbals, the area in which the choke playing may be detected may be expanded in the radial direction; therefore, it is possible to accurately detect that the choke playing has been performed.

Further, the seat sensor 9 is attached substantially half the circumference of the edge frame 5 (see FIG. 1), and the cushioning material 8 that pushes the seat sensor 9 is formed in an annular shape that is continuous in the circumferential direction. That is, the cushioning material 8 is configured to continuously contact the seat sensor 9 from one end to the other end of the seat sensor 9 (the entire seat sensor 9) in the circumferential direction. As a result, the pressure when the cushioning material 8 is compressed may be reliably detected by the seat sensor 9, for example, compared with the case where the cushioning material 8 contacts the seat sensor 9 intermittently in the circumferential direction. Therefore, it is possible to more accurately detect that the choke playing has been performed.

Such pinching of the seat sensor 9 by each frame and the cushioning material 8 may also occur when one of the bow frame 4 and the edge frame 5 is hit. Due to the pressure detected by the seat sensor 9 at the time of hitting, there is a possibility that it may be erroneously determined that the choke playing has been performed even though the player is performing the hitting.

In this regard, in this embodiment, it is determined that the choke playing has been performed when a predetermined pressure detected by the seat sensor 9 continues for a predetermined period of time (for example, 0.1 seconds). That is, the musical tone being generated is attenuated when the sheet sensor 9 detects that the bow frame 4 and the edge frame 5 are pinched (gripped) for a predetermined period of time or longer. As a result, it is possible to suppress erroneous determination that the pressure detected by the seat sensor 9 at the time of hitting is the pressure due to the choke playing.

Although the disclosure has been described based on the above embodiments, the disclosure is not limited to the above embodiments, and it can be easily inferred that various modifications and improvements can be made without departing from the spirit of the disclosure.

In the above embodiment, the electronic cymbal 1 was exemplified as an example of the electronic percussion instrument, but the disclosure is not limited thereto. For example, the configurations of the above embodiments may be applied to electronic pads. Therefore, for example, the bow frame 4 (first frame) and edge frame 5 (second frame) may be formed in a rectangular or other polygonal shape. That is, the technical ideas of the above embodiment may be applied to any electronic musical instrument that generates different musical tones depending on the difference in hit positions between the upper surface and the outer edge part (edge portion) of the upper surface of the electronic percussion instrument.

In the above embodiment, the bow frame 4 and the edge frame 5 are each supported by the rod 2 via one support rubber 3, but the disclosure is not limited thereto. For example, the bow frame 4 and the edge frame 5 may be supported on the rod 2 by separate support rubbers, or the bow frame 4 and the edge frame 5 may be supported on the rod 2 by a member formed using a material other than rubber (for example, an elastic body such as an elastomer).

That is, in the above embodiment, the support rubber 3 made of rubber was exemplified as an example of the elastic body for supporting each frame on the rod 2, but the elastic body for supporting each frame on the rod 2 preferably uses a material that is at least softer than each frame. As a result, it is possible to suppress propagation of vibration to the other frame via the elastic body when one of the frames is hit.

It may be configured that one of the frames is supported by the rod 2 via an elastic body, and the other frame is attached to the one frame via the cushioning material 8 (both upper and lower surfaces of the cushioning material 8 are attached to each frame with double-sided tape or the like). That is, it may be configured that the other frame is not in contact with the rod 2 by supporting only one of the frames on the rod 2 and supporting the other frame on the rod 2 via the one frame and the cushioning material 8.

In the above embodiment, the piezo pickup was exemplified as an example of the bow sensor S1 and the edge sensor S2 that detect the vibration of the bow frame 4 and the edge frame 5, but the disclosure is not limited thereto. For example, a known sensor such as a piezoelectric sensor, an electrodynamic sensor, or a capacitive sensor may be applied as long as it may detect the vibration of each frame.

In the above embodiment, the case has been described in which one bow sensor S1 and one edge sensor S2 are attached near the center of the bow frame 4 and the edge frame 5, but the disclosure is not limited thereto. For example, multiple bow sensors S1 and edge sensors S2 may be provided, or may be disposed at a position closer to the outer edge side than the center of the bow frame 4 or the edge frame 5.

In the above embodiment, the case has been described in which the slits 43 are radially formed (the slits 43 are formed linearly along the radial direction) in the bow portion 42 of the bow frame 4, but the disclosure is not limited thereto. For example, the slit 43 may be curved or linear extending in the circumferential direction, or may be a combination of curved lines and straight lines (for example, a wave shape or a zigzag shape). Also, the slit 43 may be formed in the bell portion 41 of the bow frame 4, or the slit 43 may be omitted.

In the above embodiment, the case has been described in which the overhang portion 54 (edge portion) of the edge frame 5 was not covered with rubber (elastic body), but the disclosure is not limited thereto. For example, the upper surface and the outer peripheral surface of the overhang portion 54 may be covered with an elastic body such as rubber (a material softer than the edge frame 5). As a result, it is possible to reduce the hitting sound at the time of hitting the overhang portion 54. Also, in order to reduce the sound of hitting the overhang portion 54, the overhang portion 54 (edge frame 5) may be formed using a relatively soft material, for example, a material softer than the bow frame 4.

In the above embodiment, the upper surface of the overhang portion 54 of the edge frame 5 is flush with the edge portion of the upper surface of the film member 7, but the disclosure is not limited thereto. For example, the upper surface of the overhang portion 54 may be positioned above or below the edge portion of the upper surface of the film member 7.

In the above embodiment, the cushioning material 8 is in contact with the bow frame 4 and the edge frame 5 (seat sensor 9) in the state before hitting, but the disclosure is not limited thereto. For example, the thickness of the cushioning material 8 may be made thinner than the gap between the bow frame 4 and the edge frame 5 so that the cushioning material 8 does not come into contact with the bow frame 4 or the edge frame 5 in the state before hitting. In the case of such a configuration, the cushioning material 8 may be formed with a thickness that does not allow the frames to come into contact with each other at the time of hitting. Alternatively, the cushioning material 8 may be omitted.

In the above embodiment, the case has been described in which the cushioning material 8 is formed in an annular shape that is continuous in the circumferential direction, but the disclosure is not limited thereto. For example, the cushioning material 8 may be intermittently formed in the circumferential direction. With this configuration, the vibration of hitting one of the bow frame 4 and the edge frame 5 is less likely to be propagated to the other frame via the cushioning material 8.

In the above embodiment, the case has been described in which the upper surface of the bow frame 4 is covered with the cover member 6 and the upper surface of the cover member 6 is covered with the film member 7, but the disclosure is not limited thereto. For example, it may be configured that the upper surface of the bow frame 4 is covered with a rubber cover.

In the above embodiment, a detailed description of the method of attaching the film member 7 to the cover member 6 has been omitted; the film member 7 may be simply placed on the cover member 6 (in a relatively displaceable state), or the film member 7 may be fixed (attached) to the cover member 6. Alternatively, the cover member 6 and the film member 7 may be omitted.

In the above embodiment, the case has been described in which the film member 7 is a plain weave fabric (mesh) formed using synthetic fibers, but the disclosure is not limited thereto. For example, the film member 7 may be formed using a non-woven fabric using synthetic fibers or a resin film. That is, the film member 7 may be made of a material that has a higher strength against hit than the cover member 6 and has a slippery upper surface (lower coefficient of friction) than the cover member 6.

In the above embodiment, the case has been described in which the sheet sensor 9 is a membrane switch, but the disclosure is not limited thereto. For example, known sensors such as conductive rubber sensors, cable sensors, and capacitive touch sensors may be used as long as they may detect the pressure when each frame is pinched. In addition, instead of detecting the pinching of each frame by pressure, a change in the gap between the frames is detected by a non-contact sensor (for example, a sensor that detects changes in magnetic field or capacitance, or an optical sensor).

Further, instead of detecting the pressure change with the sheet sensor 9, it may be configured to detect that each frame is pinched by ON/OFF of the sensor. In this case, if the ON time of the sensor continues for a predetermined period of time, it may be determined that the choke playing has been performed (and the musical tones that have already been generated are attenuated). As a result, it is possible to prevent an erroneous determination that the sensor ON at the time of hitting is the choke playing.

In the above embodiment, the case has been described in which the seat sensor 9 is provided between the edge frame 5 and the cushioning material 8, but the disclosure is not limited thereto. For example, the seat sensor 9 may be provided between the bow frame 4 and the cushioning material 8, or may be attached to the lower surface of the edge frame 5. Alternatively, the sheet sensor 9 may be omitted.

### REFERENCE SIGNS LIST

1: electronic percussion instrument

2: rod

3: support rubber (elastic body)

4: bow frame (first frame)

41: bell portion

42: bow portion

43: slit

5: edge frame (second frame)

6: cover member

7: film member

8: cushioning material

9: seat sensor (third sensor)

54: overhang portion (edge portion)

S1: bow sensor (first sensor)

S2: edge sensor (second sensor)

1. An electronic percussion instrument comprising:
a first frame having an upper surface configured as a hit surface;
a first sensor attached to the first frame for detecting vibration of a hit to the first frame;
a second frame disposed below the first frame in a non-contact state with the first frame and having an outer edge that is located on an outer peripheral side of an outer edge of the first frame to form an edge portion; and
a second sensor attached to the second frame for detecting vibration of a hit to the second frame.

2. The electronic percussion instrument according to claim 1, further comprising an elastic body supported by a rod,
wherein the first frame and the second frame are supported by the rod via the elastic body.

3. The electronic percussion instrument according to claim 2, further comprising a cushioning material having a predetermined elasticity and provided between a lower surface of the outer edge side of the first frame and an upper surface of the second frame,
wherein contact between the first frame and the second frame is restricted by the cushioning material in response to the first frame or the second frame being hit.

4. The electronic percussion instrument according to claim 3, wherein the cushioning material is formed continuously in a circumferential direction centering on the rod, and
a space between the first frame and the second frame is closed by the cushioning material.

5. The electronic percussion instrument according to claim 3, further comprising a third sensor provided between the cushioning material and the first frame or the second frame,
wherein a musical tone being generated is attenuated in response to the third sensor detecting that the first frame and the second frame are pinched.

6. The electronic percussion instrument according to claim 5, wherein a musical tone being generated is attenuated in response to the third sensor detecting that the first frame and the second frame are pinched for a predetermined period of time or longer.

7. The electronic percussion instrument according to claim 1, wherein the first frame is configured as an electronic cymbal having a bell portion and a bow portion, and
the second sensor is disposed at a position overlapping with the bell portion when viewed in a vertical direction.

8. The electronic percussion instrument according to claim 1, wherein an upper surface and an outer peripheral surface of the edge portion of the second frame are not covered with an elastic body.

9. The electronic percussion instrument according to claim 1, further comprising:
a cover member made of foamed resin that covers the upper surface of the first frame; and
a film member covering an upper surface of the cover member and having a higher strength than the cover member,
wherein the film member is a woven fabric or non-woven fabric formed using synthetic fibers, or a resin film.

10. The electronic percussion instrument according to claim 9, wherein the first frame includes a plurality of slits penetrating vertically.

11. The electronic percussion instrument according to claim 10, wherein the first frame is configured as an electronic cymbal having a bell portion and a bow portion,
the first sensor is attached to the bell portion, and
the slits are formed radially centering on the first sensor side.

12. A hit detection method for an electronic percussion instrument, wherein the electronic percussion instrument comprises:
a first frame having an upper surface configured as a hit surface;
a first sensor attached to the first frame for detecting vibration of a hit to the first frame;
a second frame disposed below the first frame in a non-contact state with the first frame and having an outer edge that is located on an outer peripheral side of an outer edge of the first frame to form an edge portion; and
a second sensor attached to the second frame for detecting vibration of a hit to the second frame,
wherein the hit detection method comprises:
determining which of the first frame and the second frame has been hit based on a ratio or difference between output values of the first sensor and the second sensor.

13. The hit detection method according to claim 12, wherein the electronic percussion instrument further comprises an elastic body supported by a rod,
wherein the first frame and the second frame are supported by the rod via the elastic body.

14. The hit detection method according to claim 13, wherein the electronic percussion instrument further comprises a cushioning material having a predetermined elasticity and provided between a lower surface of the outer edge side of the first frame and an upper surface of the second frame,
wherein contact between the first frame and the second frame is restricted by the cushioning material in response to the first frame or the second frame being hit.

15. The hit detection method according to claim 14, wherein the cushioning material is formed continuously in a circumferential direction centering on the rod, and
a space between the first frame and the second frame is closed by the cushioning material.

16. The hit detection method according to claim 12, wherein the first frame is configured as an electronic cymbal having a bell portion and a bow portion, and
the second sensor is disposed at a position overlapping with the bell portion when viewed in a vertical direction.

17. The hit detection method according to claim 12, wherein an upper surface and an outer peripheral surface of the edge portion of the second frame are not covered with an elastic body.

18. The hit detection method according to claim 12, wherein the electronic percussion instrument further comprises:
a cover member made of foamed resin that covers the upper surface of the first frame; and
a film member covering an upper surface of the cover member and having a higher strength than the cover member,
wherein the film member is a woven fabric or non-woven fabric formed using synthetic fibers, or a resin film.

19. The hit detection method according to claim 18, wherein the first frame includes a plurality of slits penetrating vertically.

20. A hit detection method for an electronic cymbal which has a first frame and a second frame, comprising:
detecting a first value of vibration to the first frame,
detecting a second value of vibration of the second frame, and
determining which of the first frame and the second frame has been hit based on a ratio or difference between the first value and the second value.
